(19) United States
(12) Patent Application Publication
(10) Pub. No.: US 2010/0332312 A1
(43) Pub. Date: Dec. 30, 2010

(54) System and method for analyzing endorsement networks

(76) Inventors: Theresa Klinger, Alamo, CA (US); Ariel Wada, Larkspur, CA (US)

Correspondence Address: Brian R. Galvin, P.O. BOX 2360, SILVERDALE, WA, 98383-2360, US

(21) Appl. No.: 12/459,438

(22) Filed: Jun. 30, 2009

(51) Int. Cl. G06Q 30/00; G06F 17/30; G06Q 10/00

(52) U.S. Cl. 705/14.43; 707/912; 707/955; 707/812

(57) ABSTRACT

A system for analysis of endorsement networks, comprising a data collection server adapted for collecting event data over a data network from a plurality of components associated with an endorsement network, one or more database servers coupled to the data collection server and adapted to store event data pertaining to the endorsement network, and an analysis module coupled to at least one of the database servers, and wherein the analysis module retrieves data pertaining to the endorsement network from at least one of the databases and conducts analysis of said data sufficient at least to determine the graph structure of a significant portion of the endorsement network, is disclosed.

### BACKGROUND OF THE INVENTION

1. Field of the Invention

The present invention is in the field of e-commerce, particularly as it pertains to virtual communities such as social networks, online gaming communities and “virtual worlds” and to content aggregators that make third-party content available to members of virtual communities. Yet more particularly, the present invention pertains to the measurement and analysis of endorsement networks, and methods for usefully leveraging results gained from such analyses.

2. Discussion of the State of the Art

In the field of entertainment media, several trends have emerged in recent years, quite separately, that when combined offer surprising new possibilities for individuals and enterprises alike. One of these trends is emergence of product placements as a new kind of advertisement. This now familiar technique involves advertisers (vendors of products such as personal computers, cars, liquors and toys, just to name a few) paying content creators (movie studios, TV studios and others) to display or refer to their products in prominent ways within the content itself. This is in stark contrast to previous practices in advertising, where the boundary between advertising and entertainment content was clearly defined; with product placements, commercial messages can be included within content for which consumers pay to view, and with which consumers are strongly emotionally engaged.

A second trend is democratization of content creation. In the age of the great movie studios, control of content creation (at least in the new media of radio and the movies) was entirely within the hands of a few very powerful businessmen. Later, as the costs of high quality production came down, and as more and more channels to market became available, first through UHF television stations and later through cable and satellite systems, content creation became more diffuse, taking place across thousands of companies acting in various capacities. But only recently has serious content routinely been created by individuals acting as consumers rather than as employees of media companies. The emergence of “user-generated content” (UGC) has been a large part of the post-2000 boom in user-centric web services, which commonly is labeled broadly as Web 2.0. Today, with blogs, personal web pages, and sites for the uploading of user-generated music and video clips, more and more of what people read, hear and watch is created outside of the corporate world and in the world of UGC.

Another important trend has been emergence of highly targeted advertising. Advertising once was a mass media affair, and segmentation tended to go no further than choosing during which radio or television shows to advertise. Today, Internet portal companies, search engines, marketing database companies with access to credit card and other financial data all compete to precisely target advertisements to ever more finely sliced segments of the consumer population. The rapid rise of Google has also shown how much the advertising equation has changed; while charging only a tiny fraction of what traditional media charged for advertising, and while permitting only the most rudimentary text-based advertising, Google has grabbed a significant share of the advertising market and has built a highly profitable business, because its ad placements are highly targeted and because advertisers only pay when ads are clicked.

Finally, the last few years have seen emergence of another new category of web-based entity, the virtual community. A well-known emerging category of virtual community is social networks. Already there are thousands of these, ranging from the very large operators such as MySpace™ or Facebook™ to very small, highly verticalized players. There are even companies selling platforms for launching new social networks quickly and inexpensively. And social networking has quickly become one of the major outlets for user-generated content (in fact, one can view each subscribers profile page as a form of UGC). As is typical in web trends, the original social networking pioneers offered “something for nothing”, and most social networking sites continue to offer a wide range of free services. But soon after, people began seeking ways to develop profitable business models to monetize the large numbers of loyal users that had been created in a very short time. Much as Google did in search, these pioneers are looking to advertising to satisfy the need to generate revenue from highly visited social networking sites, and they are typically adopting the methods used by Google—allowing users to provide advertisers access to their profile pages in return for a small slice of the advertising revenue. This is by now a well-understood business model—the site operator, the user whose profile page is used, the media buyer and others each take a piece of the total advertising spend committed by the advertisers (these by and large are the same kinds of companies as in all of the previous ages plus the new web-based companies).

Beyond social networks, other forms of virtual communities have become commonplace in the art. Among these are online gaming communities in which large numbers of individuals cooperate and compete in network-hosted gaming systems. Many of these are typified by games that are indefinite in nature, and it is common for complex social structures similar to social networks to arise intentionally or merely as a result of actions taken by many people in pursuit of their goals. Many online gaming communities include a strong element of user-generated content, with similar challenges and opportunities for monetization of this content. Other forms of virtual communities typified by widespread adoption and propagation of user-generated content, and the concomitant need for means to monetize that content, include “virtual worlds” and file sharing communities. All of these are merely exemplary of a strong shift away from static content to user-generated content in the online world, and these examples should not be considered to be limiting for the purposes of the present invention. All virtual communities in which user-generated content plays a prominent role provide background for, and will benefit from, the present invention.

Additionally, a vigorous new e-commerce market category has emerged recently commonly referred to as content aggregators. These sites, which resemble virtual communities and may be considered a subset of that category, allow users (whether individual consumers, boutique content creation companies, or major media outlets) to upload content that can then be searched and viewed freely by users of the content aggregator sites. Importantly, these sites generally also provide rich functionality for tagging, rating and commenting about content by any and all users. These sites are actively experimenting in methods for monetizing their sites, generally by placing ads on their page that are targeted based on the content viewing selections of individual users or groups of users. Additionally, these sites have enabled the embedding of advertising within the content on their sites, such as at-predefined insertion points (or times) in streaming videos. In the art at the time of the present invention, the methods known to the inventors all involve the selection of advertisements for insertion by the content aggregator or a partnered advertising network.

One limitation of the currently emerging model of allowing advertisers to place ads on users' profile pages and other user-controlled or user-generated content hosted in virtual communities is that it is a largely passive affair from the users' point of view. A user can, for instance, subscribe to one of the many affiliate advertising services and make a space available for ads to be displayed, but the user has no control over what ads are displayed. Advertisers will display ads that seem to correlate well with the content of the page (for instance, a user's blog on “the new physics” will likely show ads from a science magazine, whereas one that focuses on a particular sports team would likely show ads promoting sports apparel or memorabilia). But the user cannot choose, and certainly the user cannot block undesirable advertisers from her page.

This limitation, besides providing for the possibility of incongruous and occasionally counterproductive ad placements, also leads to an inability of mainstream advertisers to take advantage of the most powerful aspect of virtual communities—which is precisely that virtual communities are self-organized market segments. People who network together whether in a broad “network of friends” sense or in a narrow “network of first edition enthusiasts” sense, automatically define segments of great interest to advertisers, as these virtual communities generally will share much in common, including buying habits. But since the essence of virtual communities is their self-organization and, accordingly, their dynamic nature, the traditional advertising model falls short.

This problem is exacerbated by the challenges faced by content aggregators. As with virtual communities, advertisement placement is largely a passive targeting function performed either by a content aggregator or by an advertising network that partners with a content aggregator. Ads can be targeted based on the tagging and commentary associated with given media content, and can be inserted in the content or on the page around the content while it is being viewed. But there is no provision in the art today for the users to select advertisements and thereby to endorse products that they prefer. Additionally, content aggregators generally only have access to advertising revenues while users are actually on their sites; if the content is allowed to be embedded and displayed on third-party sites (such as a user's profile page in a virtual community), the content creator and content aggregator have no way to make money except by inserting ads into the media itself without any knowledge of where the content is being viewed, or by whom.

As a result of these trends, new methods for monetizing content based on the use of endorsements, rather than advertisements, have emerged. According to these methods, members of virtual communities provide endorsements of products or services they deem worthy, generally associating these endorsements with user-generated content (their own or another's), either by embedding endorsements directly in such content or placing them in close proximity with the content so that their association is evident. In some methods known to the inventors, product endorsements (product here and hereafter is used broadly to refer to anything that can be sold, and therefore includes services and intangible products as well as tangible products) are adapted to allow content viewers to select an endorsement, view it, buy the product or add it to a shopping cart, and even copy the “embed code” of the endorsement in order to reuse the endorsement themselves. Furthermore, in some methods known to the inventors, endorsers and the communities where they place their endorsements receive compensation in some form based on the various responses received to their endorsements (for instance, by receiving a small fee each time an endorsement is viewed, and another if the endorsed product is sold).

Efforts have been underway for some time to measure and study social networks, especially with the recent emergence of large-scale online communities that are easily measurable. This analytical effort has taken place alongside efforts to mine the very large databases of online behaviors (such as browsing web pages) to attempt to understand the behavior of online users. The goal in some cases is purely scientific (especially in the case of social network studies, which began in the 1950's and are part of the fabric of the social sciences), but in other cases significant commercial motives are present. Largely these commercial motives have centered around the notion of identifying the specific areas of interest of a given online user in order to be able to advertise more effectively (for example, showing a sports-related ad to a sports fanatic is likely to be much more cost-effective than showing it to the conductor of a philharmonic who is viewing a biography of Beethoven). Similarly, efforts have been made to measure the effectiveness of online advertising, taking advantage of the particularly data-rich environment that is the Internet (compared with older media such as television, magazines, and newspapers, where no methods exist to measure exactly when specific viewers are receiving a particular ad impression, nor to gage what actions any user takes in response to an ad impression). In traditional media, the analytical focus was on mass markets and demographics, and on the creation of brands through many impressions targeted at creating particular emotional responses in particular audiences. By contrast, in online advertising it is possible to measure, in many cases, not only whether an advertisement is viewed by a particular user, but also whether the user spent time “dwelling on” the ad, or whether she clicked through to the site linked to by the ad (and, since this site usually belongs to the advertiser, what the user does once she arrives there). In possession of a map of a social network, advertisers can also look for trends in which closely linked individuals respond similarly to specific types of advertisements.

Most efforts to monetize social networks online to date have focused on advertising. This is not surprising, as advertising is a very well-known method of communicating an offer to consumers and of building brands, and advertising has for centuries been the primary method of monetizing new communications media (for instance, newspaper ads started in the eighteenth century). And advertisers are always on the lookout for media that enable precise targeting of advertisements. Online media are excellent for this, because it is possible to leverage both users' online behaviors and the content that is being viewed by a user at any given time. In the first case, analyzing user behaviors can often allow a site operator or an advertising network (or Google) to determine what a given consumer's interests are. One of the very first successful models on the Internet was to form large networks of affiliate sites and to use cookies to track individual consumers' usage of those sites to determine what topics are of interest to that consumer, and then to target ads accordingly. In the second case, full-text analysis of pages being viewed (or of videos being watched, although this is harder to do) allows advertisers to target ads by showing them when consumers are viewing related content. Thus when an online consumer is reading an article about sports, sports-related ads (or ads relating to subjects that are known to be strongly correlated with sports in the target demographics' minds, for example beer and fast cars) would be shown to the consumer. This is analogous to showing fishing ads in fishing magazines, but with a much higher degree of refinement (no one knows when or whether a purchased magazine is read, or by whom, but online everything is visible).

However, there are serious shortcomings to the present state of the art. Advertising analytics are very good for deciding where to place ads, and how to build the ads (what copy leads to the highest click-through rates, and so forth), but they are very limited in what they can tell us. The current studies of social networks are not generally focused on the propagation of information across networks (although there is work on the study of the propagation of disease in “real” social networks, that is social networks that involve physical social contact as opposed to online social contact). And, advertisements do not move. Users don't like ads, and they rarely are able, or have any desire to, copy them and place them somewhere else. Moreover, the placement of advertisements is always under the control of the advertiser, or the advertising network operator. Users, that is, those who are the targets of ads, do not place ads. They may, according to the art, place advertising slots on their own pages (personal web pages, blogs, microblogs posts, and the like), but the choice of which advertisements go into each of the slots is made by others. Analyzing the behaviors of users in the presence of advertisements will tell you something about what the users' interests are, and their susceptibility to various types of persuasion, but it will not tell you anything about what they really care about.

Endorsement-based systems, such as described above briefly (and in the inventors' previous patent applications), offer a much richer source of data for the analysis of user preferences, behaviors, and economic activities. Unlike advertisements, endorsements are made by users, and therefore the process by which a specific user (or broad set of users) selects products to endorse, and how they endorse the products, can be viewed and measured by the operators of virtual communities and of endorsement platforms. Furthermore, when observing a viewing user's response to another user's content and associated product endorsements, the situation is fundamentally different than when observing a user's response to an ad. Advertisements are placed by entities that are generally uninteresting from an analytical point of view; a car ad is placed by an automotive manufacturer or maybe a dealer. It is understood by all, including the viewer, that their one and only goal is to sell the user a car. In the case of endorsements, however, when a viewer is contemplating an endorsement of the same car the analyst is presented with a richer data set, because the identity, behavior, degree of connectedness to the viewer, and even reputation of the endorser are all “knowable” and potentially useful variables. Each endorsement viewing represents an interaction between two “persons of interest” to the analyst, especially insofar as the endorser is also frequently an endorsee. Furthermore, endorsements can, and normally will, move (unlike ads). If one viewer views a particularly interesting endorsement of a movie from someone she knows and respects, she may decide to forward the endorsement on to other friends; in other cases, she may decide to copy the endorsement and post it (perhaps modified) in her own content space. Thus the notion of endorsements propagating across social networks is both real, and readily measured. This completely new degree of visibility is the focus of the present invention, which enables the practitioner to analyze endorsement-related behaviors in communities.

### SUMMARY OF THE INVENTION

In an effort to solve the problems described above of monetizing user-generated content and third-party content, the inventors conceived of a fundamental shift in the longstanding paradigm of advertising. Specifically, they conceived of the notion of shifting from the model of vendors hawking their own wares through various advertising means involving the pushing of vendor materials to potential consumers to the model of users promoting and selling products that they personally find valuable or useful. Accordingly, the inventors provide a system for the monetization of user-generated or third party content using user-controlled product placements within, adjacent to, or near the content.

According to a preferred embodiment of the invention, a system for analysis of endorsement networks, comprising a data collection server adapted for collecting event data over a data network from a plurality of components associated with an endorsement network, one or more database servers coupled to the data collection server and adapted to store event data pertaining to the endorsement network, and an analysis module coupled to at least one of the database servers, is disclosed. According to the embodiment, the analysis module retrieves data pertaining to the endorsement network from at least one of the databases and conducts analysis of said data sufficient at least to determine the graph structure of a significant portion of the endorsement network.

According to another preferred embodiment, a method for analysis of endorsement networks is disclosed. The method starts by receiving endorsement-related events from a plurality of components associated with an endorsement network, aggregating the event data to build a statistical model of the endorsement network, and analyzing the endorsement network model to determine at least a significant portion of the graph structure of the endorsement network. Furthermore, and using the graph structure and statistical data, the method comprises selecting one or more nodes of the endorsement network for signal injection, injecting at least a signal to those nodes via one or more of email, advertisement, or special web content, and monitoring the effectiveness of the signal injection. Finally, according to the method, at least the statistical model of the endorsement network is modified based on the results of the signal injection.

### BRIEF DESCRIPTION OF THE DRAWING FIGURES

FIG. 1 (PRIOR ART) is an illustration of a social network graph, as known in the art.

FIG. 2 is a block diagram of components of the invention in one embodiment, highlighting different roles played in carrying out the invention.

FIG. 3 is a process flow diagram of a method of the present invention.

### DETAILED DESCRIPTION

The inventors provide, in one embodiment, a system and a method for the analysis of endorsement networks, such as virtual communities in which endorsers are enabled to select from a variety of products (wherever products are referred to herein, it should be understood to include not only physical products, but also virtual products such as game items for online games, and services, without departing from the scope of the present invention), from a variety of merchants, and to make them available for viewing and purchase entirely within, or associated with, their own or another's content. That is, it is an object of the present invention that the behavior of endorsers who are able to choose product information about products of their choosing and to embed that information, in a variety of ways, into their own or another's content is made susceptible to fruitful analysis, such as by operators of virtual communities or merchants desiring to sell products through endorsement networks into virtual communities. “Content” as used herein should be understood to include any content capable of being associated with arbitrary additional content, either by having the additional content embedded within it or closely associated with it at the time the content is consumed. For instance, the emergence of portable electronic readers and highly functional smartphones means that content including (but not limited to) books, audio selections, or short videos (or even feature-length movies) can be propagated to, and consumed using, these devices. Thus content, as used herein, would include an electronic book viewed offline, as long as the electronic book and the associated viewing device make it possible for endorsements to be either embedded in the book (by its publisher or by another), or to be associated with it at the time the content is “consumed” (read, in this case). Thus, the term “content” should be construed quite broadly when considering the scope of the instant invention.

Most people, when thinking of the term “social network”, think of an online community such as MySpace™. But the term generally means something much more: it refers to the “network” of connections between people. Long before MySpace™, social networks were a reality with which all humans were accustomed to deal. In a very real sense, there is one, global, social network which links each human being to every other human being through a multiplicity of connection paths, where connections are family relationships, friendships, neighborhood ties, social ties within a community, workplace ties, and even the ties we have to the people with whom we routinely interact for commercial purposes.

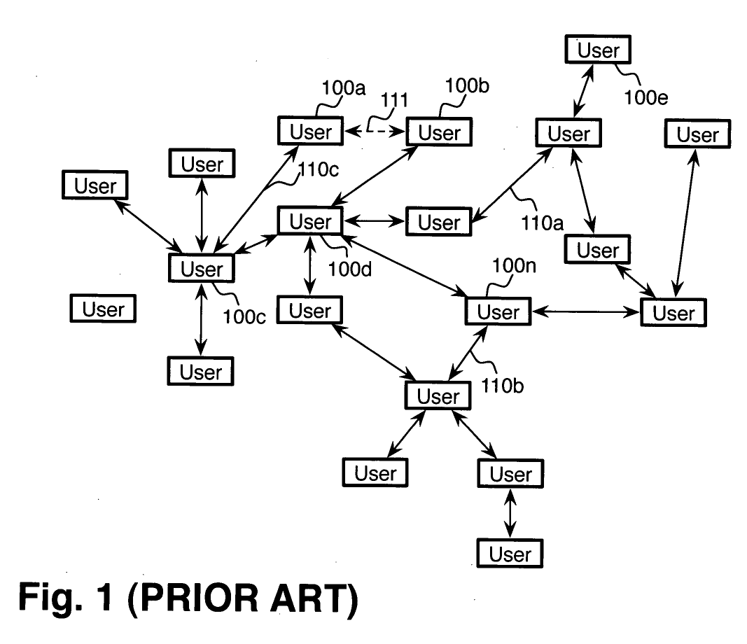

The best way to visualize social networks is as graphs, like that shown in FIG. 1. Users 100 (often called nodes) shown in the graph represent individuals, and the lines 110 (called edges) represent relationships between individuals. The example shows a connected graph: it is possible to get from any user 100 on the graph to any other user 100, by following at least one continuously connected path along edges 110. In an unconnected graph, there would be islands that are disconnected from the main part of the graph, or perhaps a few isolated individuals (nodes) with no contacts at all (an extremely unrealistic scenario!). It is easy to see, when looking at the graph of FIG. 1, that some people are highly connected and others are very sparsely connected to others; in fact, real social networks (whether “physical” or for example in a virtual community) tend to come in “hub and spoke” topologies. Scientists (sociologists and applied mathematicians mostly) have been studying the structure and dynamics of networks intensely over the last 50 years, starting with the famous “six degrees of separation” experiment by Stanley Milgram and pioneering theoretical work by mathematicians Erdos and Renyi.

In fact, “the social network” is a very large graph with something like 7 billion nodes, which represents all humanity. Obviously this graph would be difficult to work with in any useful way, but the situation is not as bad as one might think. Google routinely works with a much larger graph that represents at least 10 billion web pages, so in principle it will soon be possible to talk about manipulating the entire global social network in a single computer! In the meantime, all “social networks” we can usefully talk about are really subsets (or subnets) of the social network. In particular, many virtual communities (many of which are called “social networks” explicitly) represent self-selected subnets of the social network, where the edges represent declared “friendships” or professional connections.

An important aspect of all social networks (including “the social network” that is the superset of all social networks) is that they are dynamic, constantly adding and dropping nodes 100, and adding edges 110. Note that edges 110 often are very long-lasting; once you have a strong connection to someone, that connection persists for a long time, even if the nature of the relationship changes (e.g., an old, estranged friend is still “connected” in a social sense). On the other hand, if two people (for example, users 100a and 100b in FIG. 1), who do not know each other, speak during a chance meeting at a coffee shop, then a transient connection 111, or graph edge, is created. Unless the two people exchange cards or take some other step to stay connected, edge 111 disappears almost as soon as the two users are physically separated (as by leaving the coffee shop). But transient edges 111 can be important, because while they exist ideas, money, legal obligations, and even diseases can be “transmitted” from one user 100a to the other 100b. For example, users 100a and 100b might exchange information about user 100e, who is connected to each of them (very distantly!).

Online communities bring a new dimension to the study of social networks. Since people opt to join these networks (providing already one clue about their preferences, or at any rate grouping people who are alike insofar as each of them has self-selected into the group by joining a specific online community), and since even the largest of them have only tens of millions of members, online communities represent reasonable objects to study. And, the types of relationships that exist within online communities are fewer in number. An edge 110 usually means simply that one or the other, or both, of two people 100 at ends of edge 110 has designated the other as a “friend” or “member”. Moreover, since operators of online communities often desire to monetize traffic and membership they attract (and since online communities tend to represent very attractive markets to product manufacturers), there is a strong economic motivation for understanding the structure of the social networks that arise in online communities.

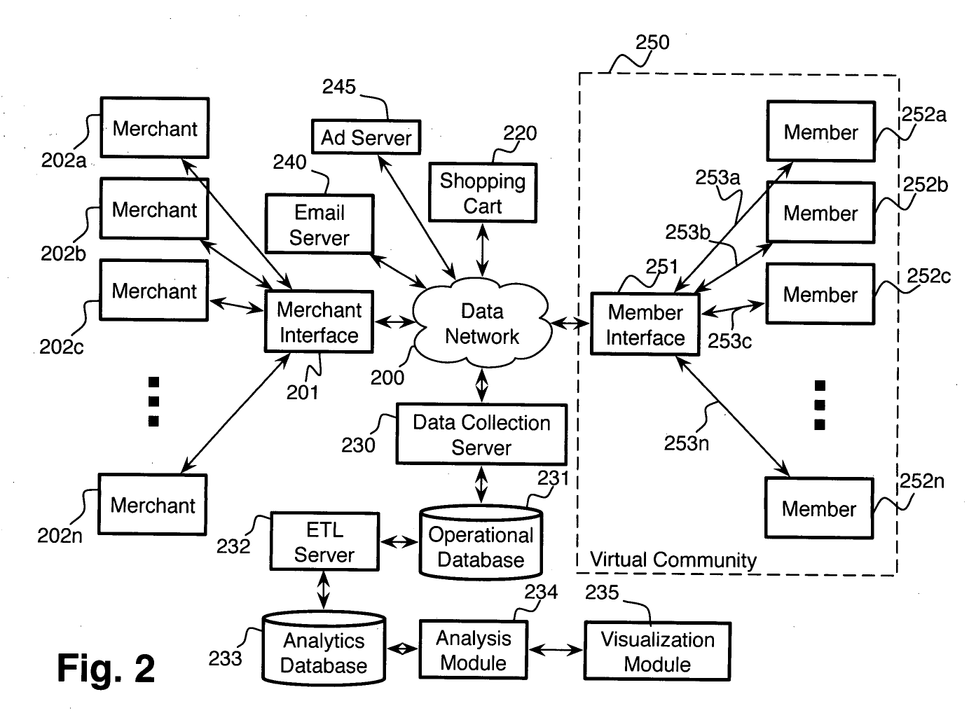

FIG. 2 illustrates an endorsement network, in which a plurality of merchants 202 is coupled to a virtual community 250 via Merchant Interface software 201, which is a single point of configuration and control for merchants (202a through 202n) desiring to make products available for promotion or sale in one or more virtual communities 250. Merchants 202 access the Merchant Interface software via the Internet or other data network 200. Merchant product data is uploaded to Shopping Cart 220, which is shown separate from virtual community 250 but could also be embedded in virtual community 250. What is important is the functions provided by Shopping Cart 220, not who carries them out or where they are located. Merchant Interface software 201 is operable either as a standalone software package that can be installed permanently on a computing device such as a personal computer, a mobile phone, or a handheld computing device. It is also, in some embodiments, comprised of software that is downloaded each time it is used from a server via a network 200 such as the Internet; in some endorsement networks Merchant Interface software 201 is adapted to be downloaded to a user on demand, either from Shopping Cart 220 or another location. It is well-known in the art for compact software to be delivered on demand to a client device over a network by a server, and any of the many means for doing this known in the art may be used according to the invention. In some endorsement networks, embed code adapted to trigger a download of Merchant Interface software 201 (when content in which it is embedded is loaded) is made available to merchants or content creators. For example, a merchant can download Merchant Interface software embed code from a Shopping Cart 220 or other server or website, and embed the embed code into her own personal website (which may not even be accessible to other users from the Internet, although it needs to be able to connect to at least one Shopping Cart 220 in order to carry out its functions). Thus when such a merchant is carrying out routine business from a personal website (which could be on an Intranet, and could include modules for popular hosted business applications), she will be able to manage her sales through the virtual community channel, loading new products for sale, adding or changing product promotions and survey instructions, and managing orders. Because of the compact form and the on-demand nature of the Merchant Interface software 201, it may be accessed from virtually anywhere, by any registered user. For instance, merchants may in some cases access the full merchant functionality from a kiosk, for example where cell phones are sold in an office supply store. In this example, a merchant not necessarily associated with the office supply store could use an in-store kiosk to review orders and to make changes to product descriptions, pricing, promotional materials, or available inventory. In another example, a consumer may add items for sale by taking pictures of the items using a mobile phone and uploading them using Merchant Interface software, along with price and delivery terms, to a shopping cart 251. The same consumer could, in the same session, also act as an endorser (preparing and uploading, or changing, product endorsements associated with content) and as a content and endorsement viewer and possible purchaser. It is envisioned by the inventors that many small business merchants and consumers will choose to sell products using Merchant Interface software 201 rather than well-known online sales means such as eBay or Amazon.com. The benefit is that each time a consumer uploads a product for sale using Merchant Interface software 201, the product is available to be endorsed and promoted by any number of virtual community members 252, indeed such users could be participating in any number of virtual communities 250. Moreover, in some endorsement networks, users may choose (typically when accessing a virtual community 250 via a third party) to make the product available for endorsement or sale in multiple virtual communities. Thus, small businesses, consumers, and large businesses are able to obtain access using a simple user interface to a potentially vast network of net promoters who will promote and sell their products.

Merchant Interface software 201 is connected via data network 200 (which can be, but need not be, the Internet) to Shopping Cart 220. Members (252a through 252n) of the virtual community are provided the ability to buy products placed in the universal shopping cart 251 by the plurality of merchants 202 using Merchant Interface software 201, and to do so either from within the familiar user interfaces of the virtual community 250 or via a specialized Member Interface 251. Interactions with Member Interface 251 are via data network connections 253, which can be the Internet but are not required to be so; any packet-based networking technology known in the art can fulfill the function of data network connections 253. In most endorsement networks, data network 200 is the Internet, but this need not be the case. It should be noted that data connections can be combined, or subdivided into special-purpose data connections such as for reporting, without departing from the spirit and scope of the present invention; data connections are shown for clarity and as an exemplary embodiment.

The interactions that take place between Merchant Interface software 201 and Shopping Cart 220 in endorsement networks encompass all functions normally associated with making products available for sale and promoting their sale in a marketplace, with the marketplace being the virtual community in which Shopping Cart 220 is embedded, or with which Shopping Cart 220 is associated.

While in an embodiment the virtual community 250 is one of the many familiar social networks available on the Internet, it should be understood that the invention can be used to market goods and services to any human network 250, for example (but not limited to) console or online gaming systems where a gaming industry participant operates Shopping Cart 220 of the invention, kiosks where content is delivered to malls or stores using the method of the invention (the Shopping Cart 220 in this case could be operated by an operator of a chain of malls, or a chain of stores, or by a specialist third party who places kiosks in prominent places to allow consumption of content by network members), virtual worlds where groups or entire virtual societies are formed and the Shopping Cart 220 is operated either by the host of the virtual world or by a third party service provider, or even offline networks such as groups of “friends and family” who subscribe to a value-added mobile phone service that allows users to create and post content that can be viewed on mobile phone service that allows users to create and post content that can be viewed on mobile phones, and where the mobile phone carrier or one of its partners operates the Shopping Cart 220.

The components of FIG. 2 described to this point are intended to illustrate a typical arrangement for effecting an endorsement capability in which Merchants 202 are enabled to make products available to members 252 of one or more communities 250, these members being thereby enabled to select products and to include endorsements of them in or associated with content that they either create or provide in one or more locations where others can view the content. While this type of endorsement network is not currently known in the prior art, it is the subject of several copending patent applications by the inventors, and the provision of endorsement capabilities to end users is not the subject of the instant invention. Explanation of this capability has been given to provide context for what follows, specifically embodiments of the instant invention that make possible the analysis of endorsement networks and acting on the results of such analyses. Accordingly, the previous descriptions of endorsement networks are purely exemplary, and any endorsement network may be analyzed according to the invention without departing from the scope of the invention.

FIG. 2 further illustrates a preferred embodiment of the invention in which an endorsement network as described above is enhanced by providing a comprehensive analytics capability. According to the embodiment, Data Collection Server 230 is adapted to receive events from at least shopping cart 220, but possible also merchant interface 201 and member interface 251. “Events” as used herein means datagram's delivered over network 200 from one or more of shopping cart 220, merchant interfaces 201, or member interfaces 251 that typically contain a time of occurrence, an event identifier, one or more identities of persons or other actors taking a role in an event, and information attributes of an event or of one or more of the actors participating in the event. While the concept of events is well-known in the art, and while any event may potentially be relevant to analysis of endorsement networks according to the invention, several examples will assist in illustrating embodiments of the invention. Events may include, for example, the registration of a new merchant with an endorsement network (taken to mean at least an operator of a shopping cart 220 that is made available to, or embedded within, at least one virtual community 250 so that members 252 are empowered to use a member interface 251 to endorse products to other members 252 or visitors of the community), the addition or deletion of products available to be endorsed, the viewing of a product by a member 252 of a virtual community 250 for possible endorsement, the selection of such a product for endorsement, the selection of content within which or alongside of which an endorsement is to be placed, the placement of an endorsement, the viewing of an endorsement by another user or member 252, the copying of an endorsement by such another user or member 252, the clicking through of an endorsement by another user or member 252, the addition of a product to a personal shopping cart within Shopping Cart 220 (as is common in the art), the purchase of an endorsed product by a user or member 252, the payment of a fee by an endorsement network to an endorser, and so forth. It is intended that all events occurring in the process of making products available for endorsement, selecting them for endorsement, endorsing them, viewing endorsements of them, and optionally purchasing them (and herein products always means products, services, virtual products, or anything else of value that can be sold via endorsements in an endorsement network) are potentially captured by data collection server 230 from one or more of the other components of an endorsement network.

Events captured by data collection server 230 are stored in essentially their raw form in operational database 231. Both operational database 231 and analytics database 233 may be relational databases such as provided by Microsoft, Oracle, IBM and the like, but they need not be. Any structured database system can suffice, even a flat file data storage system in which each event is stored as a line of text in a file. Furthermore, operational database 231 and analytical database 233 may be stored in one or more database servers (server computers carrying out at least common database storage services, such as are well known in the art), either together in one, jointly distributed across more than one, or separately, each in one or more database servers, without departing from the scope of the invention. Indeed in some cases, no separate analytics database 233 will be used, but all data is analyzed in its “raw” form directly from operational database 231. In most embodiments, data in operational database 231 will be extracted periodically, transformed into a form (or data model) more suited for analysis, and loaded into an analytics database 233 ETL server 232 (ETL, as is known in the art, stands for extract, transform, and load). In some embodiments, data will be transformed in ETL server 232 and stored in analytics database 233 in data elements organized by user session, for example by grouping all events for which a particular user is a participant and that occur in close time proximity. For example, a user might log in to her social network at 11:07 in the morning, view several new content items suggested by her friends, and then view an endorsement inserted by someone she knows into a video she has elected to watch. On seeing the endorsement, she may have elected to click through, and may even have decided to place the endorsed product in her personal shopping cart, and then gone back to viewing the video. She may then have viewed several more videos, some of which may have had product endorsements that she elected not to view. Then she may have read a close friend's latest blog posts, one of which includes an endorsement of a particular book the friend read and recommends. The viewing user may elect to view the endorsement, and while doing so she decides to go back to her shopping cart to buy the first product, which she had left there. Then she logged out and became invisible to the social network and the endorsement network analytics system. All of the events from her logging in to her logging out in this example would constitute one session, and would be stored as one object in analytics database 233. In other embodiments, data is transformed into other abstract models (rather than sessions) by ETL server 232 and stored accordingly in analytics database 233. There are any number of logically possible models, including in some cases pre-aggregating raw data according to several “dimensions” such as time dimensions (aggregated by quarter hours, hours, days, months, etc.), space dimensions (less relevant to online than to offline retail, but for example breaking data down by country where respective web sites are located), or organizational dimensions (which social networks, and which groups within social networks, were associated with events). This dimensional approach to data modeling for analysis is often used in data marts and data warehouses (which are to be considered two examples of analytics database 233).

Users desiring to analyze data stored in analytics databases typically use one of a large variety of analysis modules 234 and visualization modules 235, and furthermore these two modules are often combined together in unified user interfaces. They are shown separately in FIG. 2 to highlight two distinct functions usually needed by analysts; neither module nor any combination thereof is itself a new invention, as various analysis and visualization tools are readily available in the art. Analysis module 234 typically provides an analyst a wide range of data management and filtering tools, and a variety of algorithmic tools for “mining” the data in analytics database for trends or patterns that may be of use to the analyst or the organization she represents. Similarly, visualization module 235 provides a variety of data visualization tools, including (for social and endorsement network analysis purposes) common visualization tools for viewing complex graphs such as social networks.

In some embodiments of the invention, novel analytical approaches are undertaken using tools described as part of a data architecture for endorsement network analysis. The events captured by data collection server 230 are novel in their breadth, at least in part because the endorsement networks these events represent have only recently begun to exist. To see this, it is useful to walk through the endorsement process again, with an eye to identifying new data elements that can be captured and analyzed according to the invention. Throughout this discussion, it is important to note that a person who endorses a product can also be a person who accepts or declines the endorsement of another product by another user; any data gathered at any step concerning any given user can be combined with data gathered at other steps concerning the same user to develop a rich profile of that user.

Assume that a member of MySpace™ is writing a note on his page about a coding project he completed over the weekend, and it includes a video demonstration of the new code. While he is working on this content, he decides to endorse the development environment he used, which he had used for the first time, to let others know how much it had improved his coding experience. So, he clicks on an “endorse” button and enters a catalog of products available for endorsement, organized (probably, but not necessarily!) by topic. He browses to find the product he is looking for. If endorser does not find a product/brand they are looking for, they may submit a “request for brand” (RFB) to the marketplace (the marketplace is the business community comprising merchants and the content endorser community), where it is posted in a “<Brand or product name> Wanted” list inside merchant interface 201 for all merchants to see. Once a merchant satisfies that brand/product need inside shopping cart 220, shopping cart 220 would let the posting user know requested products are now available in member interface 251 (all users who submitted RFBs with like products will be notified of the new product's availability in the system). Since he may have done this many times before, a new kind of data is being collected: data concerning the types of products this member is likely to endorse, and also behavioral data about how the user finds the products (search box, direct navigation, or somewhat random browsing, perhaps looking for a suitable product to endorse). This tells the community a lot about this user as a consumer, but it also tells a lot about the user as an endorser (which is new): is he only interested in endorsing particular products he has previously selected, or is he open to new ideas? Or, is the user trying to run a business and does many endorsements on a very proactive basis, or does he only occasionally endorse products?

Once a member selects a product to endorse, another data-rich decision awaits: how will she endorse it? Some users will always embed promotional material provided by vendors in videos they have created; others will routinely write their own product reviews and then provide a link to the shopping cart functionality for those readers of the review who choose to consider buying the product. Some will choose to endorse products or services in support of a cause, while others do it for fun, or as part of their editorial activity, and yet others do it only to make money.

Once an endorsement is made and the related content is posted with the endorsement, the situation is in some ways similar to that of an advertisement that has been placed: is it viewed, by whom, and when, and do those who view it “take the bait” and click on the endorsement/ad? But, unlike most advertising scenarios, it is possible to go further with endorsement networks, because when a viewer does click on an endorsement, she stays “on the endorser's page” while viewing product information, and possibly buying, in a pop-up or embedded widget. This means it is possible to measure every step from content creation, product selection and endorsement, content and endorsement viewing, acceptance of endorsements, and product viewing and purchase, and all in one platform, and one data set, stored first in operational data store 231 and then optionally, in one or more abstraction models, in analytics database 233.

According to the invention, it is possible to go further still to do something much more novel and useful. Because endorsements can propagate in a way ads can't, because this propagation is directly measurable, and because in an endorsement-centric community it is possible to see two sides of consumer behavior (endorsing and accepting endorsements), endorsement networks make it possible to understand the dynamics of the social networks within a community as never before. Consider how endorsements can be propagated, where ads cannot. When a member of a community views an endorsement, she could ignore it, or she can accept (click through) the endorsement, viewing more information about the endorsed product or service and possible buying it. Since users cannot control ads, nor can they be certain that a given ad will be in one place when they (or someone else) returns, there is no sense in which an ad can be propagated across a social network. Product impressions and information gleaned from the ad might propagate, but if it does so it will do so invisibly, as it is not possible to measure. On the other hand, if a first viewer is really impressed by a piece of content she read that was prepared by another user (and that included an endorsement), she can tell others or send a link to others, and thus get others in her social network to check out the content. In the same way, a different user might be really impressed by a particular endorsement of a product by another user, and might choose to pass the endorsement itself along to others. Because they can go directly to the endorsement (unless the posting user deletes it), this is possible (it isn't, for advertisements), and the endorsement “propagates” along the social network. Finally, and again this is different than with ads, if one user likes another's product endorsement, that user can endorse the same product. Again, the endorsement propagates along the social network.

What is really important here is that all data concerning member selections can be captured by data collection server 230 and analyzed using analysis module 234 and visualization module 235. Moreover, since operators of online communities 250 have complete information about structural characteristics of social networks within their respective communities, the data on endorsement propagation can be analyzed with reference to underlying social networks. For example, a visualization (using visualization module 235 or its equivalent) of a social network within a community could be made in which each node's size is determined by whether or not the user corresponding to that node has endorsed any products, and if so, how many. Larger circles represent regular endorsers. This same visualization could be further refined so that a node's size reflects a more refined “endorser index” which reflects how many endorsements, over what period of time, with what percentage of acceptance, and with how many sales, a user corresponding to a particular node has made. Clearly this visualization would be useful (especially if you look at large circles that have many edges connected to them, meaning heavy endorsers with lots of friends). But, it is missing something. It is not enough to know that a user, for example dparton999, is a huge endorser, even if she has lots of friends. We also need to know if the user is being heard by her friends, or is she singing in the shower (to herself?).

One of the really powerful things that come with a network-centric way of analyzing data is that you can analyze flows. Flows aren't important (at least, they're not readily measurable) in an advertising world, but in a world of propagating endorsements they are crucial. Identifying heavy endorsers whose endorsements propagate outward to great distances in one or more social networks represents a strategic win of the highest order, and is a key capability introduced by the instant invention. Such users “get the word out” in a powerful way, and can be referred to as super-endorsers.

Another interesting thing that can be discovered, when one analyzes endorsement behaviors in a social network context, is how an endorsement network “looks” (or, more correctly, what is the structure of a given endorsement network?). One can view a social network as before, but where edges represent endorsements that were at least viewed. That is, if a user endorses a product and another views content with that endorsement, then the second user is part of the first user's individual endorsement network. Note that edges in endorsement networks could be viewed as directional, based on who was endorser and who was “endorsee” (in some cases, two users may each act in both roles, relative to the other, making a directional link or two coincident unidirectional links). When one links all of these individual endorsement networks (which is the same thing one does to create the overall social network graph), one gets the overall endorsement network graph of a virtual community such as, say, MySpace™. And, this can be done for all endorsements, or for only endorsements of a particular type, such as endorsements of sports-related products and services, or endorsements embedded in videos. This is similar to doing a heat map of the social network for particular topics (i.e., “show me, via a color scheme, how the sports topical interest is distributed in the social network”). In fact, one can combine these techniques to display a “sports network” or a “country music network” within an overall community; such a view will show, for example, how connected the country music lovers in your community are, and who key influencers within that subnet are.

While identifying super-endorsers is important, it is more important to link analysis to action, and indeed this is an important object of the present invention. Like all forms of business analytics it is important to look for actions that can be profitably taken to leverage the newly obtained knowledge. Put another way, actionable insights can in principle make money, but merely interesting ones generally cost money (after all, it costs money to find out who the super-endorsers are in a community). Fortunately, the richness of the data, both in terms of volume and in terms of structure, make possible a number of very useful and novel techniques for leveraging endorsement network analytics. At the most basic level, one could use a mixed advertising and endorsement approach to reach a target market. The insights gained from studying am endorsement network can be used to target ads. As one might expect, this is not the most exciting approach, but it is not without merit. Endorsements provide a much stronger indication of user interest than, for example, merely viewing a web page containing related content. This is because an endorsement is a conscious and positive action that takes some time to take and that represents an implicit investment and a risk: a user's reputation among her friends and social network could suffer if she carelessly endorsed products for which general approbation was lacking.

More interesting is the notion of “nudging” a social network by actively promoting appropriate products to key influencers/endorsers. If a vendor or community operator knows that dparton999 has a huge country music following, the vendor or community could “ask” her to endorse a new product that is expected to appeal to her endorsement network. Incentives provided to prospective endorsers can be many and varied, from simply asking, through free products, to a percentage of overall sales through a social network of a target product. One could even reward a strong endorser with a percentage of all sales from within her “endorsement basin” (the area in the social network within her individual endorsement network).

Community operators could actively market themselves to product vendors as highly-productive marketplaces relative to anything that can be achieved by advertising. Insights gained from social network endorsement analytics can be used to show the value that the endorsement approach delivers relative to advertising. To this end, community operators could also use reputation systems and differential compensation based on volume and reputation to stimulate active, and effective, endorsements by the member base in a community, thus making the community more attractive to merchants. Promotions could be targeted based on topical endorsement networks' actual structure (which can only be discovered through the use of endorsement network analytics, as disclosed herein).

In a more passive variation of the idea of nudging the endorsement network disclosed above, it is possible to practice targeted “signal insertion” into a social network. Given a detailed map of endorsement patterns, especially one that is tailored by topical area, it is possible to “get the word out” by placing ads using ad server 245, sending emails using email server 240, or otherwise communicating to a selected group of individuals who can be expected to naturally spread the word. These individuals will not always, or even typically, be the same as the easily-detected “highly-connected members” of a community, who appear as superconnected nodes in the community's social network graph. Rather, they will be the ones who are highly-connected in the endorsement network (they many only have a slightly-above-average degree of connectedness when measured simply in terms of friend counts).

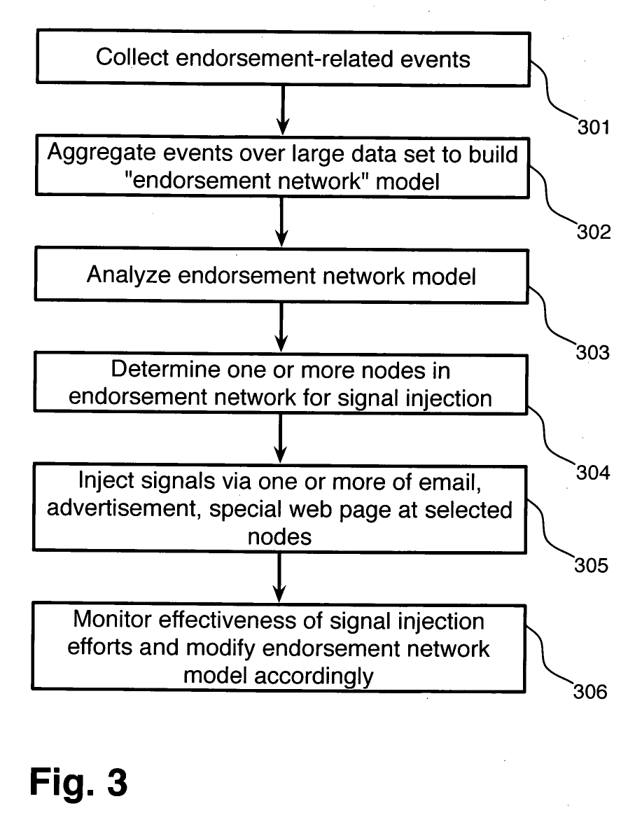

FIG. 3 outlines a method of the present invention for leveraging endorsement networks to proactively communicate with specific target audiences within a community. As described above in a first step all endorsement-related events are collected in step 301. These events are aggregated in step 302 to build a model of the endorsement network, which is then analyzed in step 303 to determine the network's structure and statistical behavior. Based on the statistics of the dynamics of endorsement effectiveness and optional endorsement propagation, in step 304 one or more nodes in the endorsement network are selected for signal injection based at least in part on the likelihood that any injected signal will propagate from selected nodes into the target subnetwork (or target audiences). In step 305 signals (messages) are injected into the endorsement network (or the social network; the two are in some sense identical in that they share the same nodes, but different in that the structure of the links between nodes differ). Signal injection can be accomplished via email, advertisement, special content on a common web page that is only viewable by targeted individuals, or special web pages made available to target users. Finally, in step 306 the effectiveness of signal injection can be directly monitored according to the invention by monitoring events associated with the signal injection and computing how well the signal injection worked (that is, looking at how far and how fast the signal propagates, and how closely its propagation follows the contours of the desired target audience). Based on this analysis, signal propagation predictions for future signal injections can be made and used to modify future communications efforts. Furthermore, signal injections can be used as a form of experiment to further understand the dynamics of the social or endorsement network. In this case, there may be no direct “payoff” from the injected signal, other than the improved knowledge of how information of various types propagates through a social network.

All of the embodiments outlined in this disclosure are exemplary in nature and should not be construed as limitations of the invention except as claimed below.

What is claimed is:

1. A system for analysis of endorsement networks, comprising:
a data collection server adapted for collecting event data over a data network from a plurality of components associated with an endorsement network;
one or more database servers coupled to the data collection server and adapted to store event data pertaining to the endorsement network; and
an analysis module coupled to at least one of the database servers;
wherein the analysis module retrieves data pertaining to the endorsement network from at least one of the databases and conducts analysis of said data sufficient at least to determine the graph structure of a significant portion of the endorsement network.

2. A method for analysis of endorsement networks, comprising the steps of:
(a) receiving endorsement-related events from a plurality of components associated with an endorsement network;
(b) aggregating the event data to build a statistical model of the endorsement network;
(c) analyzing the endorsement network model to determine at least a significant portion of the graph structure of the endorsement network;
(d) using the graph structure and statistical data, selecting one or more nodes of the endorsement network for signal injection;
(e) injecting at least a signal to those nodes via one or more of email, advertisement, or special web content;
(f) monitoring the effectiveness of the signal injection; and
(g) modifying at least the statistical model of the endorsement network based on the results of the signal injection.
